(19) United States
(12) Patent Application Publication
(10) Pub. No.: US 2026/0141383 A1
(43) Pub. Date: May 21, 2026

(54) METHOD FOR MACHINE LEARNING MODEL VERIFICATION AND TRANSACTION

(71) Applicants: Inventec (Pudong) Technology Corporation, Shanghai (CN); INVENTEC CORPORATION, TAIPEI CITY (TW)

(72) Inventors: Yu Te KU, TAIPEI CITY (TW); Yu XIAO, TAIPEI CITY (TW); Ming-Chien HO, TAIPEI CITY (TW); Chih-Fan HSU, TAIPEI CITY (TW); Wei-Chao CHEN, TAIPEI CITY (TW); Feng-Hao LIU, TAIPEI CITY (TW); Ming-Ching CHANG, TAIPEI CITY (TW); Shih-Hao HUNG, TAIPEI CITY (TW)

(21) Appl. No.: 19/452,413

(22) Filed: Jan. 19, 2026

Related U.S. Application Data
(62) Division of application No. 18/420,744, filed on Jan. 23, 2024.

(30) Foreign Application Priority Data
Nov. 16, 2023 (CN) 202311532865.8

(51) Int. Cl. G06Q 20/40; G06Q 20/38; H04L 9/00; H04L 9/06

(52) U.S. Cl. CPC G06Q 20/401; G06Q 20/389; H04L 9/008; H04L 9/0618

(57) ABSTRACT

The present disclosure provides a method including: generating a first private key and a public key according to a parameter set of full homomorphic encryption; encrypting test data and label by the public key to generate test data ciphertext and label ciphertext; generating a smart contract executed by a blockchain system, and transferring control of an amount of cryptocurrency from a first cryptocurrency account to the blockchain; receiving a result of a verification to a model ciphertext; when the result indicates that the model ciphertext does not pass the verification, retrieving the control of the amount of cryptocurrency; and when the result indicates that the model ciphertext passes the verification, receiving the model ciphertext and a second private key from the blockchain system, and decrypting, according to the first and second private keys, the model ciphertext to generate a model to infer the test data.

### CROSS-REFERENCE TO RELATED APPLICATION

This application is a Divisional Application of the U.S. application Ser. No. 18/420,744, filed Jan. 23, 2024, which claims priority to China Application Serial Number CN 202311532865.8 filed Nov. 16, 2023, all of which are herein incorporated by reference in their entireties.

### BACKGROUND

### Field of Invention

The present disclosure relates to a method for machine learning model verification and transaction, and more particularly, a method for machine learning model verification and transaction based on fully homomorphic encryption.

### Description of Related Art

There are two roles, a model buyer and a model provider, in a machine learning model transaction. It is necessary to verify a model provided by the model provider to confirm that the model provided by the model provider meets the criteria of the model buyer. However, how to ensure the confidentiality of the data and the model of the model buyer and the model provider respectively and perform the verification with a secure computation method is important. In addition, during procedures of the transaction, fraud might be committed by both the model buyer and the model provider. For example, the model buyer receives the model without paying, or the model provider does not provide the model or provide a model that is not verified after receiving the payment. Through digital technology automatically fulfilling the described verification and transaction, the coercion of a contract of the transaction and the security of the data can be ensured with human resources saved.

### SUMMARY

In some embodiments, the method for machine learning model verification and transaction provided by the present disclosure includes: generating a first private key and a public key according to a parameter set of full homomorphic encryption; encrypting test data and label of the test data separately by the public key to generate test data ciphertext and label ciphertext; generating, according to the test data ciphertext and the label ciphertext, a smart contract executed by a blockchain system, and transferring control of an amount of cryptocurrency from a first cryptocurrency account to the blockchain; receiving a result of a verification to a model ciphertext that is performed by the blockchain according to the smart contract; when the result indicates that the model ciphertext does not pass the verification, retrieving the control of the amount of cryptocurrency; and when the result indicates that the model ciphertext passes the verification, receiving the model ciphertext and a second private key from the blockchain system, and decrypting, according to the first and second private keys, the model ciphertext to generate a model to infer the test data.

In some embodiments, the method for machine learning model verification and transaction provided by the present disclosure further includes:
publishing model requirements; receiving a transaction request corresponding to the model requirements from an electronic device; and when the result indicates that the model ciphertext passes the verification, transferring the control of the amount of cryptocurrency to a second cryptocurrency account different from the first cryptocurrency account.

In some embodiments, the method for machine learning model verification and transaction provided by the present disclosure includes:
generating a first private key and a public key according to a parameter set of full homomorphic encryption; encrypting a model by the public key to generate a model ciphertext, in which the model is configured to infer test data; providing the first private key and the model ciphertext to a blockchain system, in which the blockchain system generates a smart contract according to the first private key, the model ciphertext, test data ciphertext of the test data and label ciphertext of label for the test data; receiving a result of a verification that is performed by the blockchain system according to the smart contract; and when the result indicates that the model ciphertext passes the verification, receiving control of cryptocurrency from the blockchain system, in which the blockchain system provides the first private key and the model ciphertext to a first electronic device, in which the first electronic device decrypts the model ciphertext to generate the model according to the first private key.

In some embodiments, the first private key is secret shared by the blockchain system to multiple nodes of the blockchain system, and when the result indicates that the model ciphertext passes the verification, the first electronic device rebuilds the first private key according to multiple shares in the nodes.

In some embodiments, the method for machine learning model verification and transaction provided by the present disclosure includes performing the following steps according to a first smart contract generated by a first private key, a second private key, test data ciphertext, label ciphertext, model ciphertext and accuracy threshold ciphertext that are generated according to a parameter set of full homomorphic encryption: secret sharing the first private key and the second private key to multiple blockchain nodes; selecting multiple verification devices, in which the verification devices are configured to perform a verification, in which the verification includes: inferring the test data ciphertext according to the model ciphertext to generate multiple inference results; performing multiple first full homomorphic encryption comparisons of the inference results with the label ciphertext to generate multiple accuracies; and performing multiple second full homomorphic encryption comparisons of the accuracies with the accuracy threshold ciphertext to generate multiple first comparison results; generating a correct comparison result according multiple third full homomorphic encryption comparisons between the first comparison results; decrypting the correct comparison result by the first and second private keys that are secret shared to generate a correct comparison result plaintext; and determining whether to provide the second private key to the first electronic device according to the correct comparison result plaintext, in which the first electronic device decrypts the model ciphertext according to the first and second private keys.

In some embodiments, each of the verification devices is configured to provide a first amount of cryptocurrency according to a second smart contract, in which generating the correct comparison result includes: classifying the first comparison results into sets, in which a third full homomorphic encryption comparison result of a same set of the first comparison results indicates being equal to each other; generating the correct comparison result according a first comparison result set that has a greatest number of comparison results among the sets, and determining one of the first comparison results that is not in the first comparison result set as a fake result; and confiscating the amount of cryptocurrency of a fake verification device that corresponds to the fake result.

In some embodiments, the method for machine learning model verification and transaction provided by the present disclosure further includes: equally distributing, according to the first smart contract, a second amount of cryptocurrency to a cryptocurrency account of each in the first comparison result set.

In some embodiments, the method for machine learning model verification and transaction provided by the present disclosure further includes: according to the first smart contract, comparing the greatest number and a number threshold; and when the greatest number is smaller than the number threshold, selecting multiple new verification devices to perform the verification again.

In some embodiments, the method for machine learning model verification and transaction provided by the present disclosure further includes: receiving a second amount of cryptocurrency from a cryptocurrency account of a model buyer; and according to the correct comparison result plaintext having a first value, determining the model ciphertext passing the verification and transferring the second amount of cryptocurrency to a cryptocurrency account of a model provider.

In some embodiments, the method for machine learning model verification and transaction provided by the present disclosure further includes:
according to the correct comparison result plaintext having a second value, determining the model ciphertext not passing the verification and transferring the second amount of cryptocurrency to the cryptocurrency account of the model buyer, and transferring the first amount of cryptocurrency that is confiscated to the cryptocurrency account of the model provider.

### BRIEF DESCRIPTION OF THE DRAWINGS

The invention can be more fully understood by reading the following detailed description of the embodiment, with reference made to the accompanying drawings as follows:

FIG. 1 is a schematic diagram of a system for machine learning model verification and transaction, in accordance with various embodiments of the present disclosure.

FIG. 2 is a flow chart of a method for machine learning model verification and transaction corresponding to the system in FIG. 1, in accordance with some embodiments of the present disclosure.

FIG. 3 is a flow chart of a method for machine learning model verification and transaction corresponding to the system in FIG. 1, in accordance with some embodiments of the present disclosure.

FIG. 4 is a flow chart of a method for machine learning model verification and transaction corresponding to the system in the FIG. 1, in accordance with some embodiments of the present disclosure.

FIG. 5 is a flow chart of additional steps of the method in FIG. 4, in accordance with various embodiments of the present disclosure.

FIG. 6 is a flow chart of additional steps of the method in FIG. 4 and FIG. 5, in accordance with various embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. Well-known implementations or operations are not shown or described in detail to avoid obscuring aspects of various embodiments of the present disclosure.

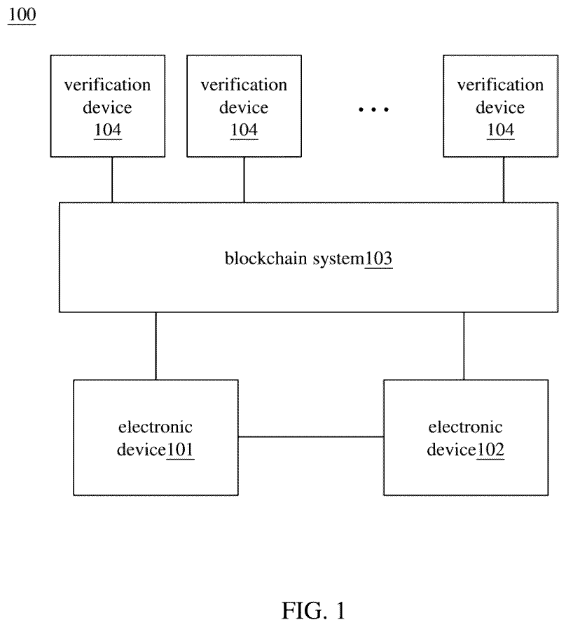

Reference is now made to FIG. 1. FIG. 1 is a schematic diagram of a system 100 for machine learning model verification and transaction, in accordance with various embodiments of the present disclosure. The system 100 verifies the machine model provided by the model provider and performs a model transaction operation between the model buyer and the model provider. For illustration, the system 100 includes an electronic device 101 of the model provider, an electronic device 102 of the model provider, a blockchain system 103 and at least one verification device 104.

As shown in FIG. 1, the electronic device 101 of the model buyer is electrically connected to the electronic device 102 of the model provider and the blockchain system 103. The electronic device 102 of the model provider is electrically connected to the blockchain system 103. The blockchain system is electrically connected to multiple verification devices 104. It should be understood that, in the scope of the embodiments of the present disclosure, the description of “electrical connection” may generally refer to the indirect electrical coupling of one element to another element through other elements, or the direct electrical coupling of an element without passing through other elements.

According to some embodiments, the electronic device 101 of the model buyer, the electronic device 102 of the model provider and the verification device 104 include a central processing unit (CPU), or other programmable general-purpose or special-purpose micro control units (MCU), microprocessors, digital signal processors (DSP), programmable controllers, application-specific integrated circuits (ASIC), graphics processing units (GPU), arithmetic logic units (ALU), complex programmable logic devices (CPLD), field-programmable gate arrays (FPGA), or other similar components or a combination of the above components.

In some embodiments, each of the electronic device 101 of the model buyer, the electronic device 102 of the model provider and the verification device 104 may further include a storage device and a transmission device. According to various embodiments, the storage device includes a hard disk, a random-access memory or other storage media. The transmission device includes a transmission interface, a transmission line, a networks device, a communication device or other transmission media.

The blockchain system 103 includes multiple blockchain nodes. The blockchain node runs/executes a smart contract deployed on a blockchain network, for example, a smart contract on the ethereum blockchain.

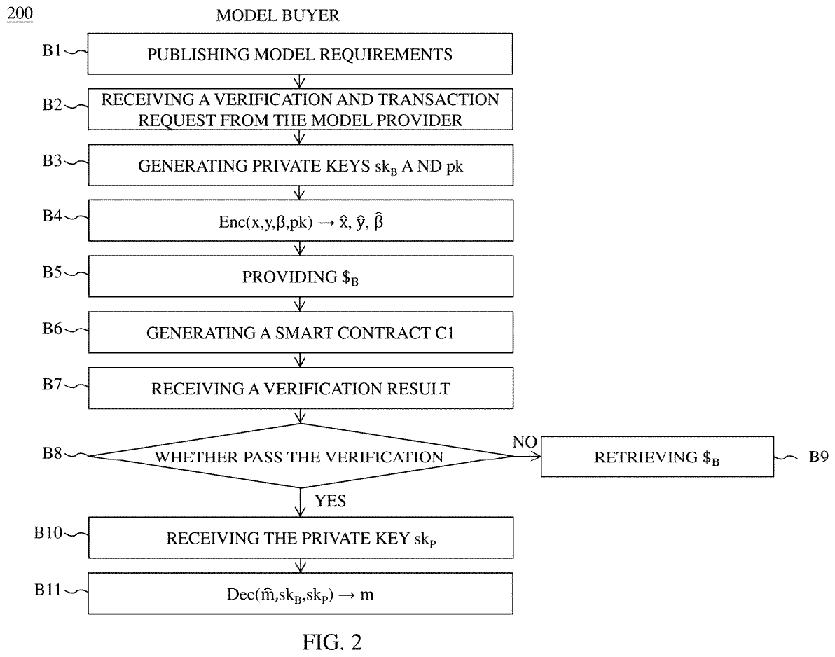

In some embodiments, the blockchain system 103 performs, according to a smart contract generated by the electronic device 101 of the model buyer and the electronic device 102 of the model provider, a full homomorphic encryption (FHE) to the data provided by the model buyer and the machine learning model provide by the model provider. The verification devices 104 infers the encrypted test data for the blockchain system 103 to verify the machine learning model. Then, the blockchain system 103 performs a transaction operation according to a result of the inference. Further detail of the method for operating the system 100 would be described below with reference to FIG. 2 to FIG. 6.

The configurations of FIG. 1, are given for illustrative purposes. Various implements are within the contemplated scope of the present disclosure. For example, in some embodiments, the electrical connections depicted in FIG. 1 can be replaced by wireless communication connections. For example, the electronic device 101 of the model buyer and the electronic device 102 of the model provider connect to each other through a wireless network.

Reference is now made to FIG. 2. FIG. 2 is a flow chart of a method 200 for machine learning model verification and transaction corresponding to the system 100 in FIG. 1, in accordance with some embodiments of the present disclosure. The method 200 includes step B1 to step B11.

In step B11, the electronic device 101 of the model buyer publishes the requirements for the machine model to purchase. For example, the requirements for the machine model includes model specifications, number of parameters, data type of the input and output data and inference accuracy, etc. In some embodiments, the electronic device 101 publishes the requirements for the machine model in a blockchain network through the blockchain system 103. In some embodiments, the electronic device 101 further publishes an amount $_{B} of cryptocurrency provided to purchase the machine learning model.

In step B2, the electronic device 101 receives a request for machine learning model verification and transaction from the electronic device 102. In operation, the electronic device 101 and the electronic device 102 perform a peer-to-peer communication to make sure that parameters of the FHE to encrypt test data x stored in the electronic device 101, label y of the test data x, a threshold β of accuracy and a machine learning model m stored in the electronic device 102 match. That is, deciding a FHE function and a parameter set thereof (e.g., the power of the FHE function or coefficients of the FHE function). The FHE function is used to encrypt the test data x stored in the electronic device 101, the label y of the test data x, the threshold β of accuracy and the machine learning model m stored in the electronic device 102. In some embodiments, the FHE in method 200 is a threshold FHE.

In some embodiments, the machine learning model m is the model provided by the model provider. The test data x and the label y are data provided by the model buyer to verify the machine learning model m. The threshold β of accuracy is a required minimum value, set by the model buyer, for the accuracy generated by comparing the label y with an inference result of the test data x.

In step B3, the electronic device 101 generates a FHE private key sk_{B} according to the FHE function. Furthermore, the electronic device 101 and the electronic device 102 generate a FHE public key pk according to the FHE function. For example, in some embodiments, the electronic device 101 and the electronic device 102 generate the same public key pk according to the FHE function. In various embodiments, the electronic device 101 generates a temporary public key and the electronic device 102 generates the public key pk according to the temporary public key and transmits the public key pk to the electronic device 101.

In step B4, the electronic device 101 performs an encryption operation Enc(x, y, β, pk) of the FHE. In the operation, the electronic device 101 encrypts the test data x, the label y and the threshold β of accuracy with the public key pk separately according to the FHE function to generate test data ciphertext \hat{x} of the test data x, label ciphertext ŷ of the label y, and threshold ciphertext \hat{β} of the threshold β.

In step B5, the electronic device 101 provides a proof of that the model buyer has the amount $_{B} of cryptocurrency required to purchase the model to the electronic device 102 and/or the blockchain system 103. In other words, the electronic device 101 provides a proof of that the cryptocurrency account of the model buyer has at least the amount $_{B} of cryptocurrency to the electronic device 102 and/or the blockchain system 103.

In step B6, the electronic device 101, the electronic device 102 and the blockchain system 103 generate a smart contract C1 together. Specifically, in some embodiments, the electronic device 101 or the electronic device 102 deploy the smart contract C1 to the blockchain network, and the blockchain system 103 executes the smart contract C1. Then, the electronic device 101 and/or the electronic device 102 provide data (e.g., test data ciphertext \hat{x} of the test data x or a storage/download link of the test data ciphertext \hat{x} and addresses of cryptocurrency accounts of the model buyer and/or the model provider) to the smart contract C1 to sign the smart contract C1. In various embodiments, the electronic device 101 and/or the electronic device 102 provide data required to sign the smart contract C1 to the blockchain system 103, and the blockchain system 103 publishes and executes the smart contract C1.

In some embodiments, the electronic device 101 transfers control of the amount $_{B} of cryptocurrency required to purchase the model to the smart contract C1. For example, the electronic device 101 generates a transaction to the blockchain network, in which the transaction is of transferring the amount $_{B} of cryptocurrency from the cryptocurrency account of the model buyer to the smart contract C1. Then, the blockchain system 103 controls, according to the smart contract C1, the cryptocurrency in the cryptocurrency account of the smart contract C1.

The smart contract C1 formulates rules of verification operation of the machine learning model m. The blockchain system 103 performs the verification operation according to the smart contract C1 and transmits a result of the verification to the electronic device 101. In step B7, the electronic device 101 receives the result of the verification from the blockchain system 103. The result indicates whether the machine learning model m passes the verification. In some embodiments, the smart contract C1 specifies that the blockchain system 103 generates the result indicating the machine learning model m passing the verification according to the inference accuracy of the machine learning model m greater than the threshold β.

In step B8, when the result indicates that the machine learning model m not passing the verification, the electronic device 101 performs step B9 to retrieve/receive control of the amount $_{B} of cryptocurrency. For example, the smart contract specifies that the blockchain system 103 transfers the amount $_{B} of cryptocurrency from the cryptocurrency account of the smart contract C1 to the cryptocurrency of the model buyer according to the result indicating the machine learning model m not passing the verification.

On the contrary, when the result indicates the machine learning model m passing the verification and the electronic device 101 performs step B10 to receive the FHE public key pk corporately generated by the electronic device 101 and the electronic device 102, the electronic device 102 generates a private key sk_{P}. Specifically speaking, the smart contract C1 specifies that the blockchain system 103 provides the private key sk_{P} to the electronic device 101 according to the result of the machine learning model passing the verification.

In step B11, the electronic device 101 performs a FHE decryption operation Dec(\hat{m}, sk_{B}, sk_{P}). In this decryption operation, the electronic device 101 decrypts the model ciphertext \hat{m}, provided by the electronic device 102, of the machine learning model m through the private keys sk_{B} and sk_{P} to get the machine learning model m to infer the test data x.

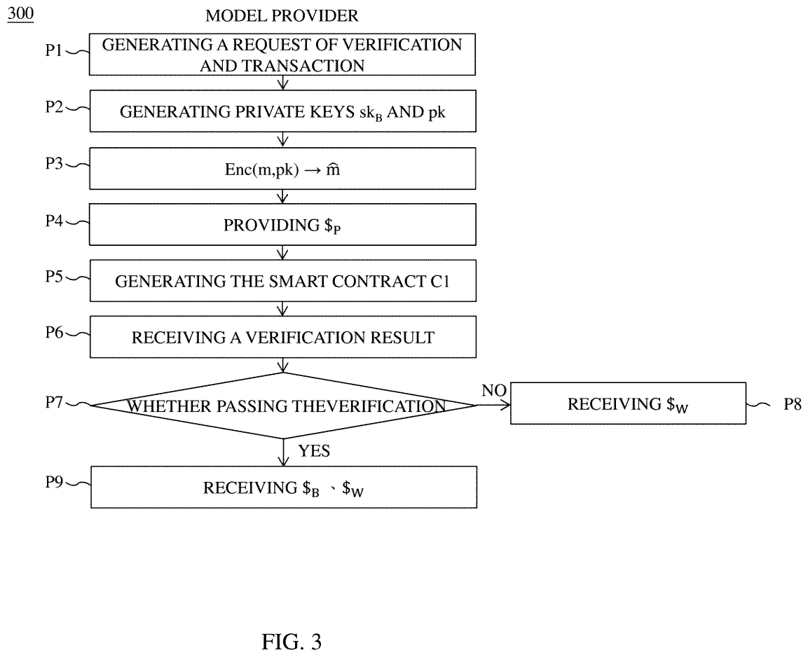

Reference is now made to FIG. 3. FIG. 3 is a flow chart of a method 300 for machine learning model verification and transaction corresponding to the system 100 in FIG. 1, in accordance with some embodiments of the present disclosure. The method 300 include step P1 to step P9. In some embodiments, the electronic devices 101 and 102 corporately operate to perform machine learning model verification and transaction according to the method 200 and the method 300 respectively.

In step P1, in accordance with the requirements for the model published by the electronic device 101 (e.g., the model requirements published in step B1 of the method 200), the electronic device 102 generates verification and transaction request. Specifically, in step P1, the electronic device 102 transmits a message of volunteering to participate the machine learning model verification and transaction. In some embodiments, in step P1, the electronic device 102 and the electronic device 101 perform a peer-to-peer communication to decide the FHE function and parameters in a parameter set of the FHE function to encrypt the test data x, the label y of the test data x, the threshold β of accuracy and the machine learning model m stored in the electronic device 102.

In step P2, the electronic device 102 generates the public key pk and the private key sk_{B} according to the FHE function and the parameter set thereof decieded in step P1. In some embodiments, the electronic devices 102 and 101 corporately generate the public key pk in the step P2 and in the step B3 of the method 200 respectively.

In step P3, the electronic device 102 encrypts the machine learning model m by the FHE function and the public key pk to generate a model ciphertext \hat{m} of the machine learning model m.

In step P4, the electronic device 102 provides a proof of that the model provider has an amount $_{P} of cryptocurrency required for verifying the model to the electronic device 101 and/or the blockchain system 103. In other words, electronic device 102 provides a proof of that the cryptocurrency account of the model provider has at least the amount $_{P} of cryptocurrency to the electronic device 101 and/or the blockchain system 103.

In step P5, the electronic device 101, the electronic device 102 and the blockchain system 103 corporately generate the smart contract C1. For example, the electronic devices 102 and 101 corporately generate the smart contract C1 in the step P5 and the step B6 of the method 200 respectively. Specifically, in some embodiments, the electronic device 101 or the electronic device 102 deploy the smart contract C1 to the blockchain network and the blockchain system 103 executes the smart contract C1. Then, the electronic device 101 and/or the electronic device 102 provide data (e.g., test data ciphertext \hat{x} of the test data x or the storage/download link of the test data ciphertext \hat{x}) to the smart contract C1 to sign the smart contract C1. In various embodiments, the electronic device 101 and/or the electronic device 102 provide data required to sign the smart contract C1 to the blockchain system 103, and the blockchain system 103 deploys and executes the smart contract C1.

In some embodiments, the electronic device 101 provides control of the amount $_{P} of cryptocurrency required for verifying the model to the smart contract C1. For example, the electronic device 101 generates a transaction to the blockchain network, in which the transaction is of transferring the amount $_{P} of cryptocurrency from the cryptocurrency account of the model buyer to the account of the smart contract C1. Then, according to the smart contract C1, the blockchain system 103 controls the cryptocurrency in the account of the smart contract C1.

According to the smart contract C1, the blockchain system 103 performs the verification operation and transmits the result of the verification of the machine learning model m to the electronic device 102. The result indicates whether the machine learning model m passes the verification. In some embodiments, the smart contract C1 formulates that according to determining the inference accuracy of the machine learning model m greater than the threshold β, the blockchain system 103 generates a result indicating the machine learning model m passing the verification. In step P6, the electronic device 102 receives the verification result from the blockchain system 103.

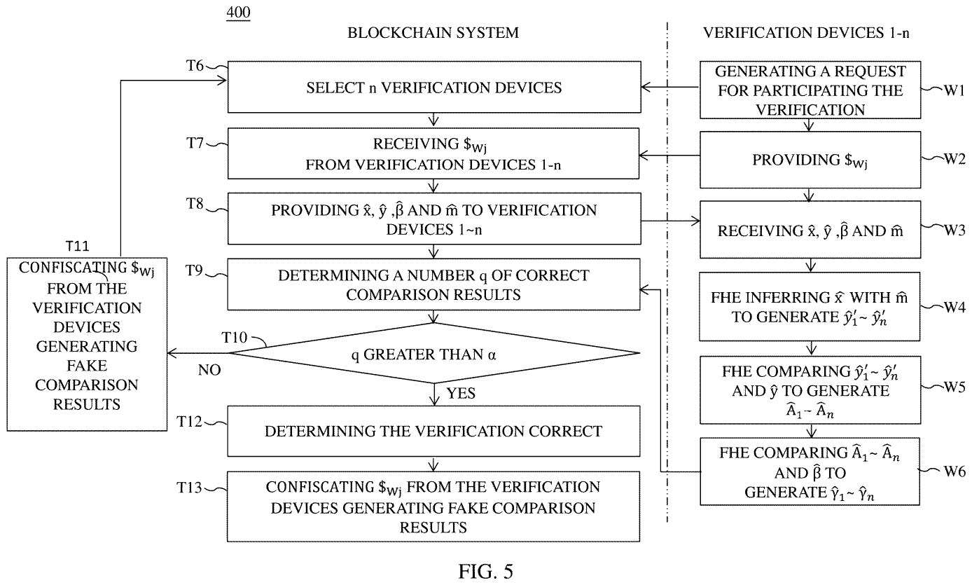

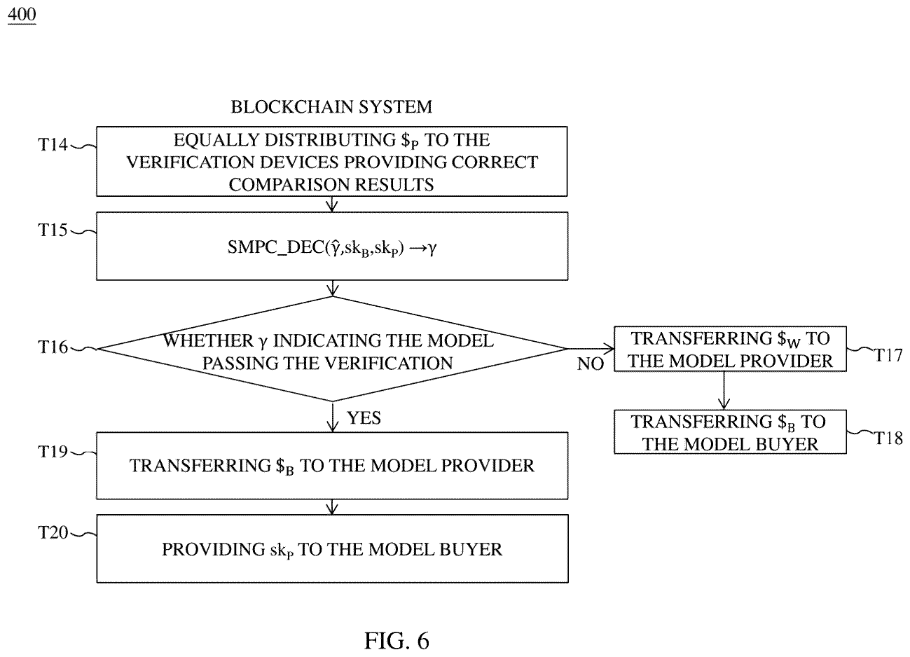

In step P7, when the verification result indicates the machine learning model m not passing the verification, the electronic device 102 performs step P8 to receive/take over control of the amount $_{W} of cryptocurrency. For example, the blockchain system 103 transfers the amount $_{W} of cryptocurrency from the account of the smart contract C1 to the cryptocurrency account of the model buyer, in which, the amount $_{W} of cryptocurrency is deposit participation fee from the verification devices 104. Related detail would be further described below with reference to FIG. 5 and FIG. 6.

On the contrary, when the verification result indicates the machine learning model m passing the verification, the electronic device 102 performs step P9 to receive the amount $_{W} of cryptocurrency and the amount $_{B} of cryptocurrency (e.g., the amount $_{B} of cryptocurrency provided by the electronic device 101 in step B5 and B6 of the method 200).

In step B11, the electronic device 101 performs a FHE decryption operation Dec(\hat{m}, sk_{B}, sk_{P}). In this decryption operation, the electronic device 101 decrypts the model ciphertext \hat{m}, provided by the electronic device 102, of the machine learning model m by the private keys sk_{B} and sk_{P} to get the machine learning model m to infer the test data x.

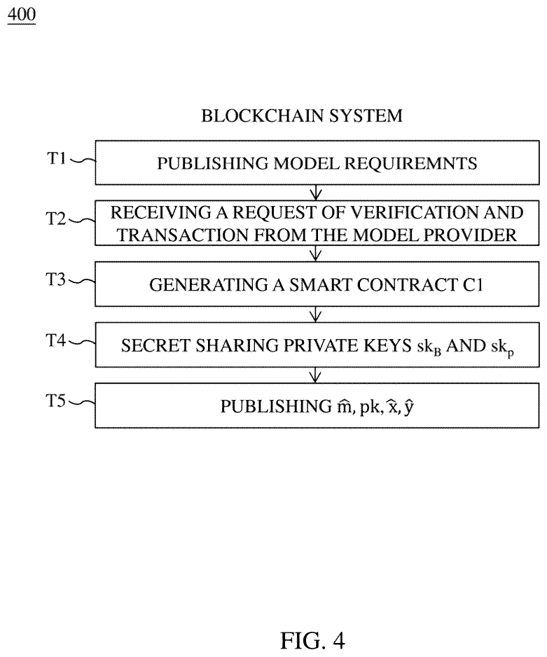

Reference is now made to FIG. 4. FIG. 4 is a flow chart of a method 400 for machine learning model verification and transaction corresponding to the system 100 in the FIG. 1, in accordance with some embodiments of the present disclosure. The method 400 includes step T1 to step T5. In some embodiments, the electronic devices 101, 102 and the blockchain system 103 corporately operate to perform the verification and transaction of the machine learning model according to the method 300 and the method 400 separately.

In step T1, the blockchain system 103 publishes the requirements for the machine learning model. For example, the electronic device 101 transmits the requirements for the machine learning model to purchase to the blockchain system 103 in step B1 of the method 200. In addition, in step T1, the blockchain system 103 publishes the requirements for the machine learning model on the blockchain network to seek a model provider.

In step T2, the blockchain system 103 receives a verification and transaction request, corresponding to the published requirements for the machine learning model, from the model provider. (e.g., the verification and transaction request generated by the electronic device 102 in step P1 of the method 300).

In step T3, the blockchain system 103 generates the smart contract C1. In some embodiments, the electronic device 101, the electronic device 102 and the blockchain system 103 corporately generate the smart contract C1. For example, the electronic devices 101, 102 and the blockchain system 103 corporately generate the smart contract C1 in step B6 of the method 200, the step P5 of the method 300 and the step T3 respectively.

In operation, the smart contract C1 is generated according to the public key pk, the private key sk_{B}, the private key sk_{P}, the test data ciphertext \hat{x} of the test data x, the label ciphertext ŷ of the label y, the threshold ciphertext \hat{β} of the threshold β, the model ciphertext \hat{m} of the machine learning model m, the amount $_{B} and the amount $_{P}. For example, in order to sign the smart contract C1, the electronic device 101 and/or the electronic device 102 provide the public key pk to the blockchain system 103, and the electronic device 101 provides the private key sk_{B}, the test data ciphertext \hat{x}, the label ciphertext ŷ, the threshold ciphertext \hat{β} and the amount $_{B} of cryptocurrency to the blockchain system 103, and the electronic device 102 provides the private key sk_{P}, the model ciphertext \hat{m} and the amount $_{P} of cryptocurrency to the blockchain system 103.

In step T4, the blockchain system 103 secret shares the private key sk_{B} and the private key sk_{P} (e.g., secret sharing the private keys sk_{B} and sk_{P} with a method of Shamir's secret sharing or Blakley's secret sharing). In some embodiments, the blockchain system 103 performs the operation of secret sharing according to the instructions (codes) in the smart contract C1. In some embodiments, the blockchain system 103 secret shares the private keys sk_{B} and sk_{P} to multiple nodes in the blockchain system 103. For example, the blockchain system 103 divides the private keys sk_{B} and sk_{P} into multiple shares through the method of secret sharing, and the described multiple nodes of the blockchain system 103 access/store the shares separately.

In step T5, the blockchain system 103 publishes the public key pk, the test data ciphertext \hat{x}, the label ciphertext ŷ, the threshold ciphertext \hat{β} and the model ciphertext \hat{m}. For example, the blockchain system 103 executes the smart contract C1 to update the state of the smart contract C1 recorded in the blockchain network, in which the state includes the public key pk, the test data ciphertext \hat{x}, the label ciphertext ŷ, the threshold ciphertext \hat{β}, the model ciphertext \hat{m}, and other published data.

Reference is now made to FIG. 5. FIG. 5 is a flow chart of additional steps of the method 400 in FIG. 4, in accordance with various embodiments of the present disclosure. As shown in FIG. 5, the method 400 further includes steps T6 to T13 and steps W1 to W6. In operation, the verification device 104 perform step W1 to step W6 to verify the model ciphertext \hat{m}.

In some embodiments, steps T6 to T13 and steps W1 to W6 are specified by the smart contract C1 and performed according to the instructions in the smart contract C1. In some embodiments, the blockchain system 103 deploys a smart contract C2 that specify the verification of the model ciphertext \hat{m}, and steps T6 to T13 and steps W1 to W6 are specified by the smart contract C2 and performed according to the instructions in the smart contract C1.

In step W1, the verification devices 104 generate a request of participating the verification to the blockchain system 103 to indicate a will of helping verify the model ciphertext \hat{m}. In some embodiments, generating the request of participating the verification is to invoke/call a function of participating the verification in the smart contract C1 or the smart contract C2.

In step T6, the blockchain system 103 selects a number n of verification devices (the verification devices 1 to n) from all the verification devices 104 that generate the participating requests. In some embodiments, the blockchain system 103 and the verification devices 1 to n sign the smart contract C2 specifying the verification of the model ciphertext \hat{m}.

In step W2, the verification devices 1 to n provide an amount $_{Wj} of cryptocurrency separately to the blockchain system 103 as the deposit or the participation fee to participate the verification. In some embodiments, the amount $_{Wj} is specified in the smart contract C1 or the smart contract C2.

In step T7, the blockchain system 103 receives control of the amount $_{Wj} of cryptocurrency provided by each of the verification devices 1 to n. Specifically, in some embodiments, each of the verification device 1 to n transfers the amount $_{Wj} of cryptocurrency from a corresponding cryptocurrency account to the account of the smart contract C1 or the smart contract C2. Then, the blockchain system 103 controls the cryptocurrency in the account of the smart contract C1 according to the smart contract C1 or controls the cryptocurrency in the account of the smart contract C2 according to the smart contract C2.

In step T8, the blockchain system 103 provides the test data ciphertext \hat{x}, the label ciphertext ŷ, the threshold ciphertext \hat{β} and the model ciphertext \hat{m} to the verification devices 1 to n. Then, in step W3, the verification devices 1 to n receives the test data ciphertext \hat{x}, the label ciphertext ŷ, the threshold ciphertext \hat{β} and the model ciphertext \hat{m}.

In step W4, each of the verification devices 1 to n performs a FHE inference operation corresponding to the FHE method. In the FHE inference operation, the verification devices 1 to n FHE infer the test data ciphertext \hat{x} with the ciphertext \hat{m} to generate inference result ŷ′₁-ŷ′_{n,} respectively.

In step W5, each of the verification devices 1 to n performs a FHE comparison operation corresponding to the FHE method. In the FHE comparison operation of step W5, the verification devices 1 to n homomorphic compare the label ciphertext ŷ and the inference result ŷ₁-ŷ′ₙ to generate the accuracy Â₁-Âₙ separately. According to some embodiments, in this FHE comparison operation, the verification devices 1 to n generate the accuracy by determining an inference result correct according to the inference result and the ciphertext of label FHE compared to be the same or to have a difference in predetermined range. For example, in some embodiments, the verification device 1 determines one of the inference result ŷ′₁ correct according to the one of the inference result ŷ′₁ and one of the label ciphertext ŷ compared to be the same, and generates the accuracy of the inference result ŷ′₁ in this way.

In step W6, the verification devices 1 to n perform the FHE comparison operations. In the FHE comparison operations of step W6, the verification devices 1 to n FHE compares the threshold ciphertext \hat{β} and the accuracy Â₁-Âₙ to generate comparison results \hat{γ}′₁-\hat{γ}′ₙ.

In step T9, the blockchain system 103 classifies the comparison results \hat{γ}₁-\hat{γ}ₙ into one or more comparison result sets according to whether the comparison results \hat{γ}′₁-\hat{γ}′ₙ being the same or having a difference smaller than a predetermined value. In some embodiments, the blockchain system 103 classifies those in the comparison results \hat{γ}′₁-\hat{γ}ₙ FHE compared to be the same into to the same comparison result set.

In step T9, the blockchain system 103 further determines one of the comparison result sets that has a greatest number of comparison results as a correct comparison result set. Then, the blockchain system 103 determines the comparison results not in the correct comparison result set as fake comparison results. The blockchain system 103 determines the ones in the verification devices 1 to n that correspond to the correct comparison result set as correct verification devices. The blockchain system 103 determines the ones in the verification devices 1 to n that correspond to the fake comparison results as fake verification devices. The blockchain system 103 determines a number q of the verification results in the correct comparison result set.

In step T10, the blockchain system 103 determines whether the number q of the correct comparison results greater than a threshold α. According to the number q of the correct comparison results smaller (or less than or equal to) threshold α, the blockchain system 103 determines the verification operation to the model ciphertext \hat{m} by the verification devices 1 to n incorrect (failing). According to determining the number q of the correct comparison results not greater than the threshold α, in step T11, the blockchain system 103 repeats performing step T6 to select a number n of new verification devices 104. The new verification devices 104 perform the verification to the model ciphertext \hat{m} again. For example, steps W1-W6 and steps T7-T10 are performed again with the new verification devices 104.

When the amount $_{Wj} of cryptocurrency provided by the verification devices 1 to n is deposit according to the smart contract C1 or the smart contract C2, the blockchain system 103 confiscates the amount $_{Wj} of cryptocurrency provided by each of the fake verification devices in step T11. In other words, the blockchain system 103 determines not to transfer/give back control of the amount $_{Wj} of cryptocurrency to the fake verification devices in the verification devices 1 to n.

In step 12, the blockchain system 103 determines the verification operation to the model ciphertext \hat{m} correct according to the number q of the correct comparison results greater than the threshold α.

In step T13, when the amount $_{Wj} of cryptocurrency provided by the verification devices 1 to n is deposit according to the smart contract C1 or the smart contract C2, the blockchain system 103 confiscates the amount $_{Wj} of cryptocurrency provided by each of the fake verification devices.

Reference is now made to FIG. 6. FIG. 6 is a flow chart of additional steps of the method 400 in FIG. 4 and FIG. 5, in accordance with various embodiments of the present disclosure. As shown in FIG. 6, the method 400 further includes step T14 to step T20.

In step T14, in some embodiments, according to the smart contract C1 or the smart contract C2, the blockchain system 103 equally divides and distributes the amount $_{P} of cryptocurrency to verification devices 104 corresponding to the correct comparison result set. Specifically, the blockchain system 103 transfers the amount $_{P}/q of cryptocurrency to the cryptocurrency account of each verification devices 104 corresponding to the correct comparison result set.

In various embodiments, according to the smart contract C1 or the smart contract C2, the blockchain system 103 transfers cryptocurrency with the amount of $_{P} divided by the number n to each verification devices 104 corresponding to the correct comparison result set. Specifically, the blockchain system 103 transfers the amount $_{P}/n of cryptocurrency to the cryptocurrency account of each verification devices 104 corresponding to the correct comparison result set.

In some embodiments, when the amount $_{Wj} of cryptocurrency provided by the verification devices 1 to n is deposit according to the smart contract C1 or the smart contract C2, the blockchain system 103 transferss the amount $_{Wj} of cryptocurrency to the cryptocurrency account of each verification devices 104 corresponding to the correct comparison result set.

In some embodiments, the blockchain system 103 performs step T15, step T16 and steps T18 to T20 according to the smart contract C1. In some embodiments, the blockchain system 103 performs step T15, step T16 and steps T18 to T20 according to the instructions in the smart contract C1.

In step T15, the 103 generates a correct comparison result \hat{γ} according to the correct comparison result set of the comparison results \hat{γ}₁-\hat{γ}ₙ. In one example, the correct comparison result \hat{γ} is a homomorphic average value of the correct comparison result set. In another example, the correct comparison result \hat{γ} is one comparison result in the correct comparison result set. Then, the blockchain system 103 performs a decryption operation SMPC_DEC of a secure multi-party computation (SMPC) under the secret sharing to the correct comparison result \hat{γ}. Specifically, one node in the blockchain system 103 decrypts the correct comparison result \hat{γ} to generate a plaintext γ of the the correct comparison result \hat{γ} by the shares of the private keys sk_{B} and sk_{P} according to the secret sharing method used in step T5.

In step T16, the blockchain system 103 determines whether the model ciphertext \hat{m} passes the verification according to the plaintext γ, in which the model ciphertext \hat{m} passing the verification indicates that the inference accuracy of the model ciphertext \hat{m} with the test data ciphertext \hat{x} as input to the model ciphertext \hat{m} is greater than the threshold ciphertext \hat{γ}. In some embodiments, the blockchain system 103 further determines the machine learning model passing the verification according to determining the model ciphertext \hat{m} passing the verification. In other words, the blockchain system 103 further determines the inference accuracy of the model m with the test data x as input to the model m is greater than the threshold ciphertext β, according to determining the model ciphertext \hat{m} passing the verification.

In some embodiments, the blockchain system 103 determines the model ciphertext \hat{m} passing the verification according to the comparison result γ has a value of “true”. On the contrary, the blockchain system 103 determines the model ciphertext \hat{m} not passing the verification according to the comparison result γ has a value of “false”.

Then, the blockchain system 103 generates the verification result of whether the model ciphertext \hat{m} or the machine learning model m pass the verification. In some embodiments, the electronic device 101 receives this verification in step B7 of the method 200 and the electronic device 102 receives this verification result in step P6 of the method 300.

According to the verification result indicating not passing the verification, the blockchain system 103 performs the step T17. In step T17, when the amount $_{Wj} of the cryptocurrency provided by the verification devices 1 to n is deposit according to the smart contract C1, the blockchain system 103 transfers an amount $_{W} of the confiscated cryptocurrency to the account of the model provider, in which the amount $_{W} of the confiscated cryptocurrency is a sum of the amount $_{Wj} of cryptocurrency provided by each of the fake verification devices.

In various embodiments, when the amount $_{Wj} of cryptocurrency provided by the verification devices 1 to n is participation fee according to the smart contract C1 or the smart contract C2, the blockchain system 103 transfers the amount $_{W} of cryptocurrency to the account of the model provider, in which the amount $_{W} of cryptocurrency is a sum of the amount $_{Wj} of cryptocurrency provided by each of the verification devices, thus the amount $_{W} is equal to n$_{Wj}.

In step T18, the blockchain system 103 transfers the amount $_{B} of cryptocurrency to the cryptocurrency account of the model buyer according to the verification result indicating not passing the verification.

In step T19, the blockchain system 103 transfers the amount $_{B} of cryptocurrency to the cryptocurrency account of the model provider according to the verification result indicating passing the verification.

In step T20, the blockchain system 103 performs a secure transmission to transmit the private key sk_{P} to the model buyer according to the verification indicating passing the verification. For example, the blockchain system 103 provides multiple shares of the private key sk_{P} to the electronic device 101 with the secret sharing method, and the electronic device 101 utilizes these shares to rebuild the private key sk_{P} according to the secret sharing method. According to the private keys sk_{P} and sk_{B}, the electronic device 101 decrypts the model ciphertext \hat{m} to generate the machine learning model m to infer the test data x.

It should be noted that, for steps in the method 200 to the method 400, the sequence in which these steps is performed, unless explicitly stated otherwise, can be altered depending on actual needs; in certain cases, all or some of these steps can be performed concurrently. Additional operations can be provided before, during, and after the steps shown by FIG. 2 to FIG. 6, and some of the steps described below can be replaced or eliminated, for additional embodiments of the method 200 to the method 400.

In view of the above, a system and method for machine learning model verification and transaction are provided. The system includes a blockchain system, an electronic device to perform the verification function of the model buyer, an electronic device to perform the verification function of the model provider and one or more verification devices to assist performing secure computing. The blockchain system is a trusted device to the model buyer and the model provider. The blockchain system executes the smart contract signed by the model buyer and the model provider to perform the model verification and transaction operations. The system and method ensure that the model buyer get a verified model and the model provider get payment when the model provided by the model provider satisfies the requirements of the model buyer.

While the disclosure has been described by way of example(s) and in terms of the preferred embodiment(s), it is to be understood that the disclosure is not limited thereto. Those skilled in the art may make various changes, substitutions, and alterations herein without departing from the spirit and scope of the present disclosure. In view of the foregoing, it is intended that the present invention cover modifications and variations of this invention provided they fall within the scope of the following claims.

What is claimed is:

1. A method for machine learning model verification and transaction, comprising:
generating a first private key and a public key according to a parameter set of full homomorphic encryption;
encrypting test data and label of the test data separately by the public key to generate test data ciphertext and label ciphertext;
generating, according to the test data ciphertext and the label ciphertext, a smart contract executed by a blockchain system, and transferring control of an amount of cryptocurrency from a first cryptocurrency account to the blockchain system;
receiving a result of a verification to a model ciphertext that is performed by the blockchain system according to the smart contract;
when the result indicates that the model ciphertext does not pass the verification, retrieving the control of the amount of cryptocurrency; and
when the result indicates that the model ciphertext passes the verification, receiving the model ciphertext and a second private key from the blockchain system, and decrypting, according to the first and second private keys, the model ciphertext to generate a model to infer the test data.

2. The method of claim 1, further comprising:
publishing model requirements;
receiving a transaction request corresponding to the model requirements from an electronic device; and
when the result indicates that the model ciphertext passes the verification, transferring the control of the amount of cryptocurrency to a second cryptocurrency account different from the first cryptocurrency account.
